(19) United States
(12) Patent Application Publication
(10) Pub. No.: US 2019/0307289 A1
(43) Pub. Date: Oct. 10, 2019

(54) Cooking Trigger

(71) Applicant: Tabitha Palmer, Mesa, AZ (US)

(72) Inventor: Tabitha Palmer, Mesa, AZ (US)

(21) Appl. No.: 16/376,754

(22) Filed: Apr. 5, 2019

Related U.S. Application Data
(60) Provisional application No. 62/654,825, filed on Apr. 9, 2018.

(51) Int. Cl. A47J 36/32; F24C 7/08

(52) U.S. Cl. CPC A47J 36/32; A47J 2202/00; F24C 7/088

(57) ABSTRACT

A cooking trigger. The cooking trigger includes a probe having a handle end and a lower end tapered to a point. A temperature sensor is disposed in the lower end of the probe that monitors the internal temperature of a piece of food. The temperature sensor is in communication with a wireless transceiver. The wireless transceiver is, in turn, in wireless communication with a controller. The controller is connected to the cooking device, wherein the controller can send a signal to sound an alarm, shut-off the power source to the cooking device, or shut-off the heating elements in the cooking device after a preset minimum internal temperature has been achieved in the piece of food.

### CROSS REFERENCE TO RELATED APPLICATIONS

This application claims the benefit of U.S. Provisional Application No. 62/654,825 filed on Apr. 9, 2018. The above identified patent application is herein incorporated by reference in its entirety to provide continuity of disclosure

### BACKGROUND OF THE INVENTION

The present invention relates to cooking signals and triggers. More particularly, the present invention provides for a cooking probe to detect the internal temperature of a piece of food and communicates wirelessly with a controller, wherein the controller can turn off a cooking device when the internal temperature of the food has reached a desired temperature.

Many foodborne illnesses can be combated by properly cooking food to the proper internal temperature. However, it can be difficult to ascertain when such a safe internal temperature of a piece of food is reached. Some individuals rely on a timer and a general prescribed average cooking time to determine when a piece of food has reached such a temperature, and is therefore safe to eat. However, cooking devices can vary drastically depending on various factors such as the manufacturer, model, and how often the device is calibrated, leading to inaccuracy. Some individuals rely on prodding the piece of food to determine the food's firmness in an effort to determine if the food is fully cooked and therefore safe to eat. However, this method relies on extensive experience with cooking the specific food item which many individuals lack.

Probe thermometers are the most accurate means of determining the current temperature of a piece of food, but it is difficult and potentially dangerous to properly access the piece of food while it is still being cooked inside the cooking device. Additionally, repeatedly opening the cooking device to check the temperature of the piece of food with a probe thermometer can lead to large temperature fluctuations as heat is lost every time the door s opened, and/or a loss of pressure which is vital when the cooking device is a pressure cooker. Accordingly, a cooking trigger that detects the internal temperature of a piece of food and communicates wirelessly with a controller, wherein the controller can turn off a cooking device when the internal temperature of the food has reached a desired temperature is desired.

The present invention substantially diverges in design elements from the known art and consequently it is clear that there is a need in the art for an improvement to existing cooking devices. In this regard the present invention substantially fulfills these needs.

### SUMMARY OF THE INVENTION

In view of the foregoing disadvantages inherent in the known types of cooking devices now present in the prior art, the present invention provides a cooking trigger wherein the same can be utilized for providing convenience for the user when checking the temperature of a piece of food without removing the piece of food from a cooking device while it is still being cooked. The present cooking trigger comprises a probe with a temperature sensor that detects the internal temperature of a piece of food, wherein the temperature sensor communicates wirelessly with a controller, wherein the controller can turn off a cooking device when the internal temperature of the food has reached a desired level.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a cooking trigger.

FIG. 2 shows a perspective view of an embodiment of the cooking trigger, in use.

FIG. 3 shows a perspective view of an embodiment of the cooking trigger, with a focus on the wireless communication.

FIG. 4 shows a schematic diagram of the function of the cooking trigger.

### DETAILED DESCRIPTION OF THE INVENTION

Reference is made herein to the attached drawings. Like reference numerals are used throughout the drawings to depict like or similar elements of the cooking trigger. The figures are intended for representative purposes only and should not be considered to be limiting in any respect.

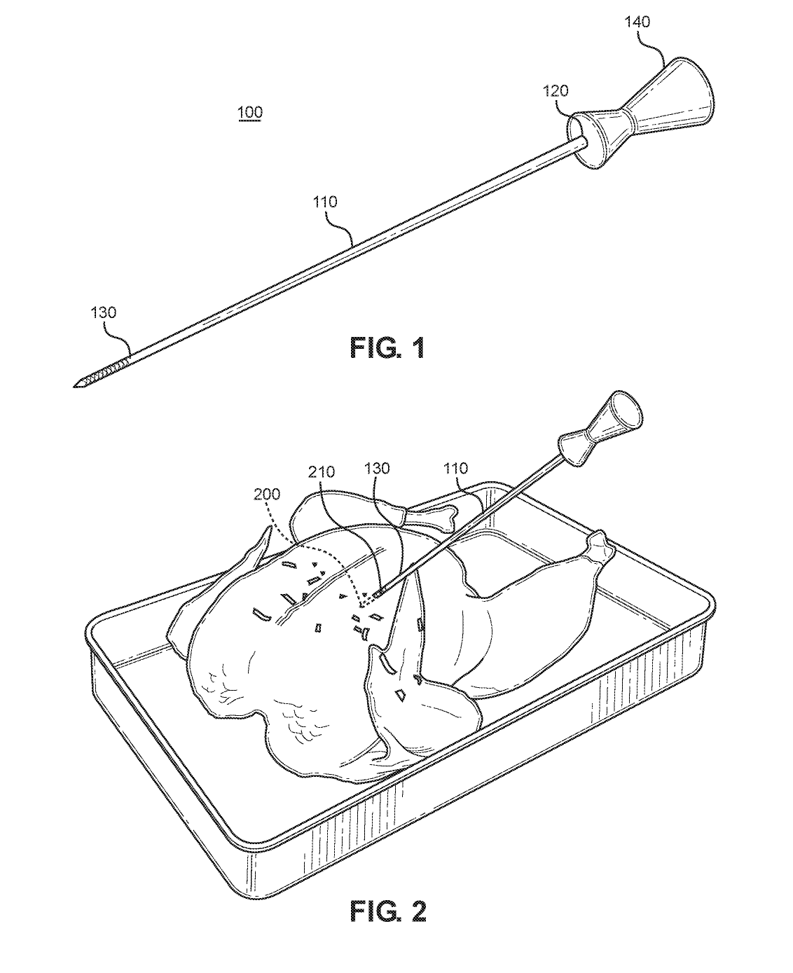

Referring now to FIG. 1, there is shown a perspective view of an embodiment of the cooking trigger. The cooking trigger 100 comprises a probe 110 having a handle end 120 and a lower end 130 tapered to a point. The cooking trigger 100 is comprised of materials that can withstand high heat, such as is experienced in an oven, or a pressure cooker. It is contemplated by this disclosure that the cooking trigger 100 is utilized in various methods of food preparation, including but not limited to baking, boiling, frying, steaming, grilling, and high-pressure cooking, and is configured to withstand the temperatures and pressures associated therewith.

The handle end 120 includes a handle 140 configured to be gripped by a user to be utilized in inserting or removing the cooking trigger 100 into a piece of food. In one embodiment, the handle 140 is ergonomically shaped in order to provide a better grip for the user. In the shown embodiment, the handle end comprises two opposing conical members, resembling an hourglass. In the shown embodiment, the handle end further comprises a distal end and a medial end, wherein the distal end of the handle end is rounded, and the medial end is planar. In the shown embodiment, the handle 140 comprises a heat-resistant material. The heat-resistant material protects a user from contacting the remainder of the probe 110 where the probe 110 is constructed from a non-heat-resistant material. In such a manner, a user can leave the cooking trigger 100 in a cooking device, such as an oven or pressure cooker, while a piece of food is cooking in the device. Thereafter, the usercan safely remove the cooking trigger 100 via the handle 140.

Referring now to FIG. 2, there is shown a perspective view of an embodiment of the cooking trigger in use. The lower end 130 of the probe 110 is tapered to a point 200. In such a manner, the lower end 130 of the probe 110 is configured to be inserted into a piece of food with minimal effort by piercing the exterior of the food with the point 200. A temperature sensor 210 is disposed in the lower end 130 of the probe 110 and is configured to read the internal temperature of the piece of food. In the shown embodiment, the probe 110 is inserted into a chicken, wherein the lower end 130 of the probe 110, and the temperature sensor 210, are disposed in the interior of the chicken. In this manner, the temperature sensor 210 is configured to continuously monitor and determine the internal temperature of the chicken as it is being cooked.

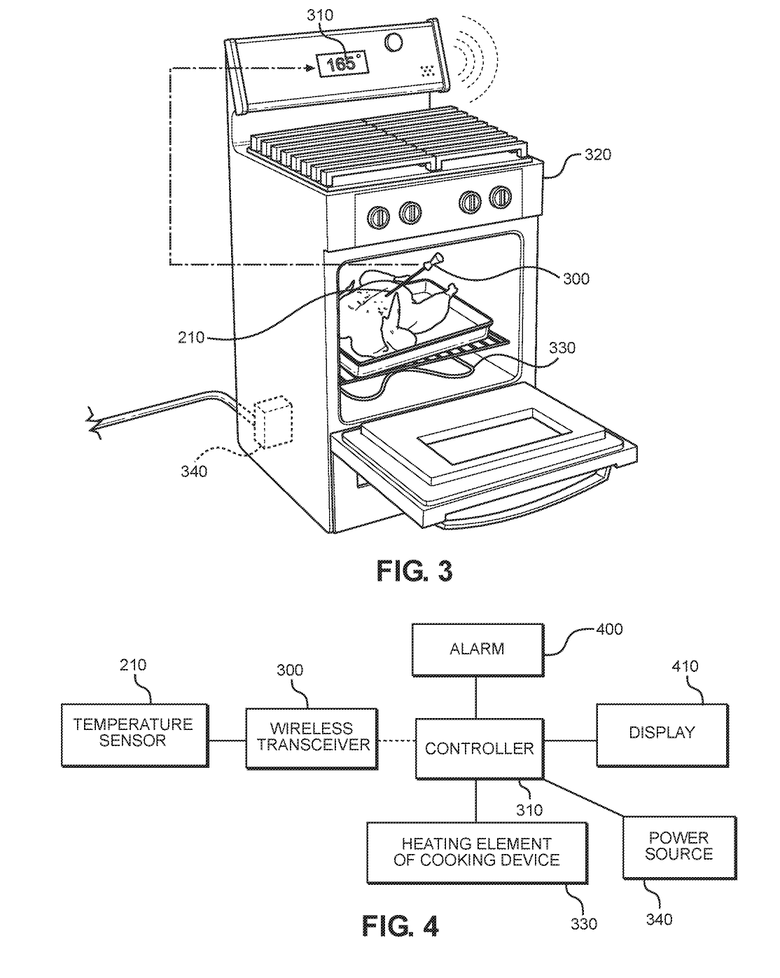

Referring now to FIG. 3, there is shown a perspective view of an embodiment of the cooking trigger, with a focus on the wireless communication. The temperature sensor 210 is in communication with a wireless transceiver 300. The wireless transceiver 300 is in wireless communication with a controller 310. In such a manner, the internal temperature of the piece of food being cooked, as determined by the temperature sensor 210, is communicated to the controller 310. The controller 310 is operably connected to a cooking device 320. In the shown embodiment the controller 310 is integrated into an oven. The controller 310 is configured to be integrated into a variety of cooking devices 320, including but not limited to an oven, a pressure cooker, or a slow cooker. In one embodiment, the controller 310 is in communication with the heating element 330 of the cooking device 320. In such an embodiment, the controller is configured to turn off the heating element 330 when a pre-determined internal temperature of the piece of food is reached, as determined by the temperature sensor 210 in the probe 110. In another embodiment, the controller 310 is in communication with the power source 340 of the cooking device 320, and thereby shut-off the cooking device 320 after a pre-determined internal temperature is measured in the piece of food. The pre-determined internal temperature is selected by the user, and in such a manner the user can utilize the cooking trigger 100 to monitor for a variety of internal temperatures in a piece of food being cooked. In one embodiment, the controller can extrapolate the trend of the temperatures being monitored by the temperature sensor 210 and can determine an appropriate time to shut off the cooking device 320 given the trend such that the piece of food will reach a desired minimum temperature and will not exceed another predetermined maximum temperature. In such a manner, the cooking trigger 100 takes into account the fact that the heat will not quickly dissipate even after the cooking device is turned off.

Referring now to FIG. 4, there is shown a schematic diagram of the function of the cooking trigger. In use the cooking trigger 100 can be inserted into a piece of food to be monitored, thereby disposing the temperature sensor 210 into the interior volume of the piece of food. The temperature sensor 210 can continuously monitor and determine the temperature inside the piece of food and communicate the temperature readings via a wireless transceiver 300 to a controller 310. The controller 10 can be in communication with an alarm 400, display 410, heating element 330, and power source 340 of a cooking device 320. The controller 10 continuously displays the internal temperature of the piece of food, as determined by the temperature sensor 210, on a display 410. In one embodiment, the display 410 is a pre-existing display in the cooking device 320. In another embodiment, the display 410 is a display that is disposed on an exterior service of the cooking device 320.

Where the temperature sensor 210 determines that the internal temperature of the piece of food has reached a pre-determined temperature, the controller 310 activates an alarm 400, deactivate the heating element 330, and/or deactivate the power source 340 of the cooking device 320. The alarm 400 can be an audio or visual alert, or a combination thereof. In this manner a user is alerted when a pre-determined internal temperature is reached in the piece of food being cooked. Additionally, upon reaching the pre-determined internal temperature of the piece of food, the controller 310 can deactivate the heating element 330 and/or the power source 340 of the cooking device 320. In such a manner, the cooking device 320 will stop producing heat and/or pressure and the manner of cooking the piece of food will cease. In such a manner, the preparation of the piece of food will cease automatically, and the piece of food will not become over-cooked.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cooking trigger, comprising:
a probe having a handle end opposite of a lower end tapered to a point;
a temperature sensor disposed in the lower end;
the temperature sensor in communication with a wireless transceiver;
the wireless transceiver in wireless communication with a controller.

2) The cooking trigger of claim 1, wherein the handle end comprises two opposing conical members, resembling an hourglass.

3) The cooking trigger of claim 1, wherein the handle end further comprises a distal end and a medial end, wherein the distal end of the handle end is rounded, and the medial end is planar.

4) The cooking trigger of claim 1, wherein the handle end comprises a heat-resistant material.

5) The cooking trigger of claim 1, wherein the controller is structurally integrated into a cooking device selected from the group consisting of a grill, an oven, a pressure cooker, and a slow cooker.

6) The cooking trigger of claim 1, wherein the controller is in operable communication with the cooking device.

7) The cooking trigger of claim 1, wherein the controller is in communication with a power source of the cooking device.

8) The cooking trigger of claim 1, wherein the controller is in communication with a heating element of the cooking device.

9) The cooking trigger of claim 8, wherein the controller is configured to turn off the heating element of the cooking device when a pre-determined temperature detected by the temperature sensor is achieved.

10) The cooking trigger of claim 8, wherein the pre-determined temperature is selected by a user.

11) The cooking trigger of claim 1, wherein the controller further comprises a display.

12) The cooking trigger of claim 1, wherein the controller is in electrical communication with a display disposed on the cooking device.

13) The cooking trigger of claim 1, wherein the controller further comprises an alarm.

14) The cooking trigger of claim 1, wherein the controller is in electrical communication with an alarm disposed on the cooking device.

15) The cooking trigger of claim 1, wherein the controller further comprises a computer-readable medium having a logic stored thereon, the controller configured to execute the logic, the logic comprising the steps of:
extrapolating the trend of the temperatures being monitored by the temperature sensor;
determining an appropriate time to shut off the cooking device given the trend such that the piece of food will reach a desired minimum temperature and will not exceed a predetermined maximum temperature;
shutting off the cooking device.
